(19) United States
(12) Patent Application Publication
(10) Pub. No.: US 2014/0258699 A1
(43) Pub. Date: Sep. 11, 2014

(54) BOOT FAULT TOLERANT DEVICE AND METHOD THEREOF

(71) Applicant: ASPEED TECHNOLOGY INC., Hsinchu City (TW)

(72) Inventors: Fu-Chou HSU, Hsinchu City (TW); Hung-Ju HUANG, Hsinchu City (TW); Chung-Yen LU, Hsinchu City (TW)

(73) Assignee: ASPEED TECHNOLOGY INC., Hsinchu City (TW)

(21) Appl. No.: 13/788,926

(22) Filed: Mar. 7, 2013

(51) Int. Cl. G06F 11/14

(52) U.S. Cl. CPC G06F 11/1417
USPC 713/2

(57) ABSTRACT

An auto firmware update device and method for fault-tolerance is provided. According to an embodiment of the invention, the auto firmware update device includes a serial port, a processor, a timer, a memory and a control unit. The serial port is used for coupling to an external device and updating firmware. The processor fetches instructions to boot. The timer is configured to start counting when the processor boots or restart each time, wherein the timer generates an alarm signal if the timer expires before the processor successfully boots. The memory stores a copy of firmware for booting. The control unit receives the alarm signal to stop the processor, downloads another copy of firmware for booting through the serial port to write to the memory, and restarts the processor.

### BACKGROUND OF THE INVENTION

1. Field of the invention

The invention relates to electronic device, and more particularly, to a boot fault tolerant device and method thereof.

2. Description of the Related Art

During the development of a System On Chip (SOC), a copy of firmware for booting of the SOC chip is updated from a flash memory. If the copy of firmware for booting of the SOC chip has errors to incur booting fault, a designer needs to pull out the SOC chip from a circuit board and re-write another copy of firmware for booting to the SOC chip.

Thus, in the above-mentioned problem, it is unacceptable for a SOC chip to fail to boot due to errors of the bad copy of firmware for booting.

### SUMMARY OF THE INVENTION

One object of the invention is to provide an auto firmware update device for fault-tolerance and provide an improved probability of successfully booting.

One object of the invention is to provide an auto firmware update method for fault-tolerance and improve the probability of a processor of a system successfully booting by a copy of firmware for booting through a serial port.

According to an embodiment of the invention, an auto firmware update device for fault-tolerance includes a serial port, a processor, a timer, a memory and a control unit. The serial port is used for coupling to an external device and updating firmware. The processor fetches instructions to boot. The timer is configured to start counting when the processor boots or restart each time, wherein the timer generates an alarm signal if the timer expires before the processor successfully boots. The memory stores a copy of firmware for booting. The control unit receives the alarm signal to stop the processor, downloads another copy of firmware for booting through the serial port to write to the memory, and restarts the processor.

According to an embodiment of the invention, A auto firmware update method for fault-tolerance includes following steps: starting a timer in response to a processor booting wherein the processor boots according to a first copy of firmware for booting; starting a control unit to stop the processor and checking if a serial port is available to provide a second copy of firmware for booting, if the timer is expired before the processor successfully boots; writing the second copy of firmware for booting from the serial port to a memory; and restarting the timer and rebooting the processor by the second copy of firmware for booting.

The embodiments of the invention of the auto firmware update device and method for fault tolerance update another copy of firmware for booting through a serial port, if a processor can not successfully boot by its built-in copy of firmware until the timer expires. This solution can provide a fault-tolerant solution for a copy of firmware with errors without requiring human intervention. A further advantage is that it not requires even a single instruction of the bad copy of the firmware to execute successfully in order to successfully boot from the good copy of the firmware.

### BRIEF DESCRIPTION OF THE DRAWINGS

The present invention will become more fully understood from the detailed description given herein below and the accompanying drawings which are given by way of illustration only, and thus are not imitative of the present invention, and wherein:

FIG. 1 shows a diagram illustrating an auto firmware update device for fault-tolerant of an embodiment of the invention.

FIG. 2 shows a diagram illustrating an auto firmware update device for fault-tolerance of another embodiment of the invention.

FIG. 3 shows a schematically diagram illustrating the auto firmware update device for fault-tolerance of an embodiment of the invention coupling to a device.

FIGS. 4A and 4B show a flow chart illustrating an auto firmware update method for fault-tolerance according to an embodiment of the invention.

### DETAILED DESCRIPTION OF THE INVENTION

In this specification and the appended claims, some specific words are used to describe specific elements. It should be understood by those who are skilled in the art that some hardware manufacturer may use different names to indicate the same element. In this specification and the appended claims, elements are not differentiated by their names but their functions. As used herein and in the claims, the term “comprising” is inclusive or open-ended and does not exclude additional unrecited elements, compositional components, or method steps. Besides, the term “coupling”, when used herein and in the claims, refers to any direct or indirect connection means. Thus, if the specification describes a first device is coupled to a second device, it indicates that the first device can be directly connected (via signal connection, including electrical connection, wireless transmission, optical transmission, etc.) to the second device, or be indirectly connected to the second device via another device or connection means.

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context.

An embodiment of the invention is to provide an auto firmware update device for fault tolerance. In an embodiment, the auto firmware update device 100 includes a mechanism which updates firmware for booting through at least a serial port if a system boot fails, and stops updating the firmware until the system successfully boots. In an embodiment, the auto firmware update device 100 includes a timer which automatically starts counting each time any system boots. If the timer expires but the system still does not successfully boot, the timer enables the auto firmware update device 100 to update firmware for booting through a serial port and then reboot the system.

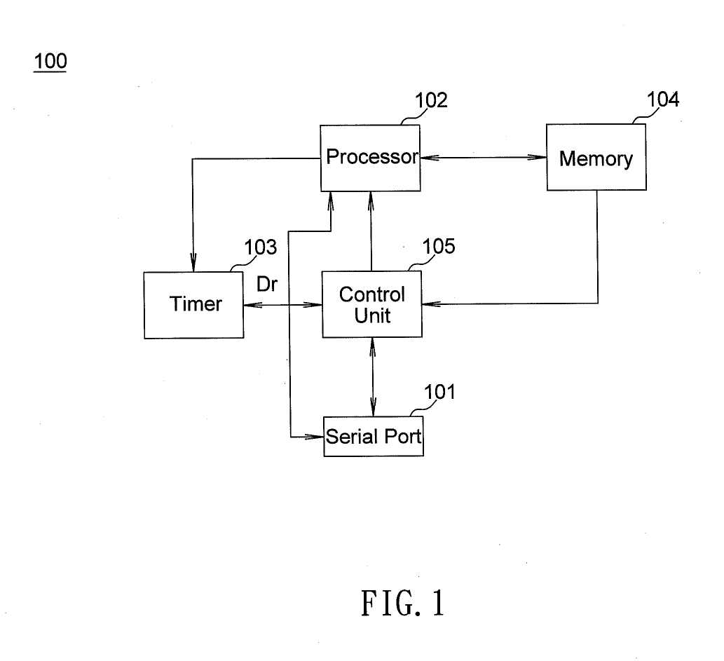

FIG. 1 shows a schematically diagram of an embodiment of the auto firmware update device 100 for fault tolerance. The auto firmware update device 100 includes at least a serial port 101, a processor 102, a timer 103, a memory 104 and a control unit 105.

The serial port 101 is used for updating firmware for booting a system. The processor 102 fetches instructions to boot the system. The timer 103 is configured to start counting whenever the processor boots or restarts. The timer 103 generates an alarm signal Dr if the timer 103 expires before the processor 102 successfully boots. In other words, the timer 103 is designed to not expire before the processor 102 successful boots. The memory 104 may be a re-writable non-volatile memory or a flash memory. The memory 104 stores a copy of firmware for booting the system. The control unit 105 receives the alarm signal Dr to stop the processor 102. Then, the control unit 105 downloads another copy of firmware for booting the system through the serial port 101 according to the alarm signal Dr. The control unit 105 writes the downloaded copy of firmware to the memory 104 and restarts the processor 102 and timer 103 for system reboot.

Please note that, in an embodiment, the serial port may be a UART port or a USB port. For example, a UART may be a RS232 port. Further the auto firmware update device 100 may be applied to a System On Chip (SOC) chip.

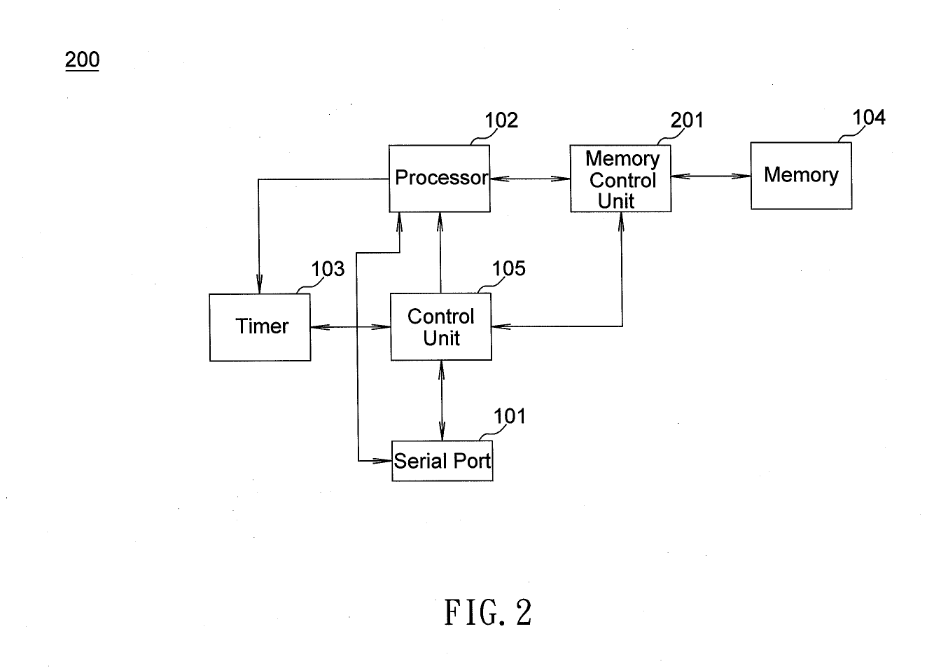

In an embodiment, referring to FIG. 2, an auto firmware update device 200 for fault tolerance further includes a memory control unit 201 for controlling and updating the memory 104. In an embodiment the memory control unit 201 may be a flash controller.

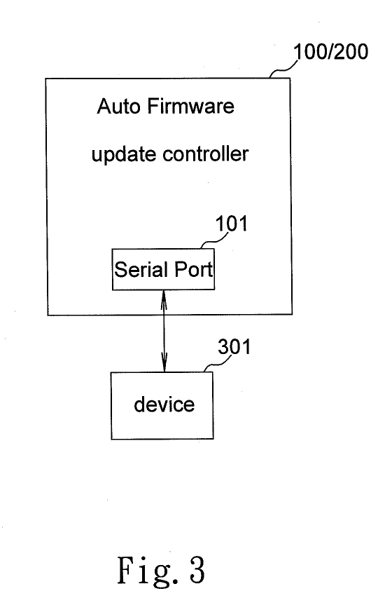

As shown in FIG. 3, the auto firmware update device 100 and 200 may be coupled to a device 301 through the serial port 101 to update firmware for booting. The device 301 may be a calculating device such as a PC (Personal Computer), a notebook computer or a mobile phone or other device may provide firmware for booting to the auto firmware update device 100 and 200.

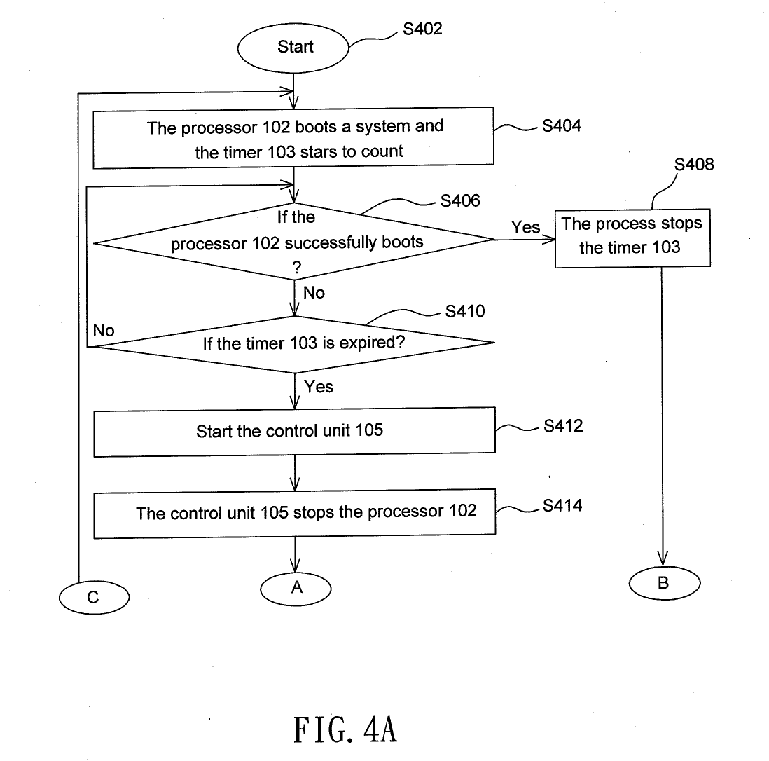

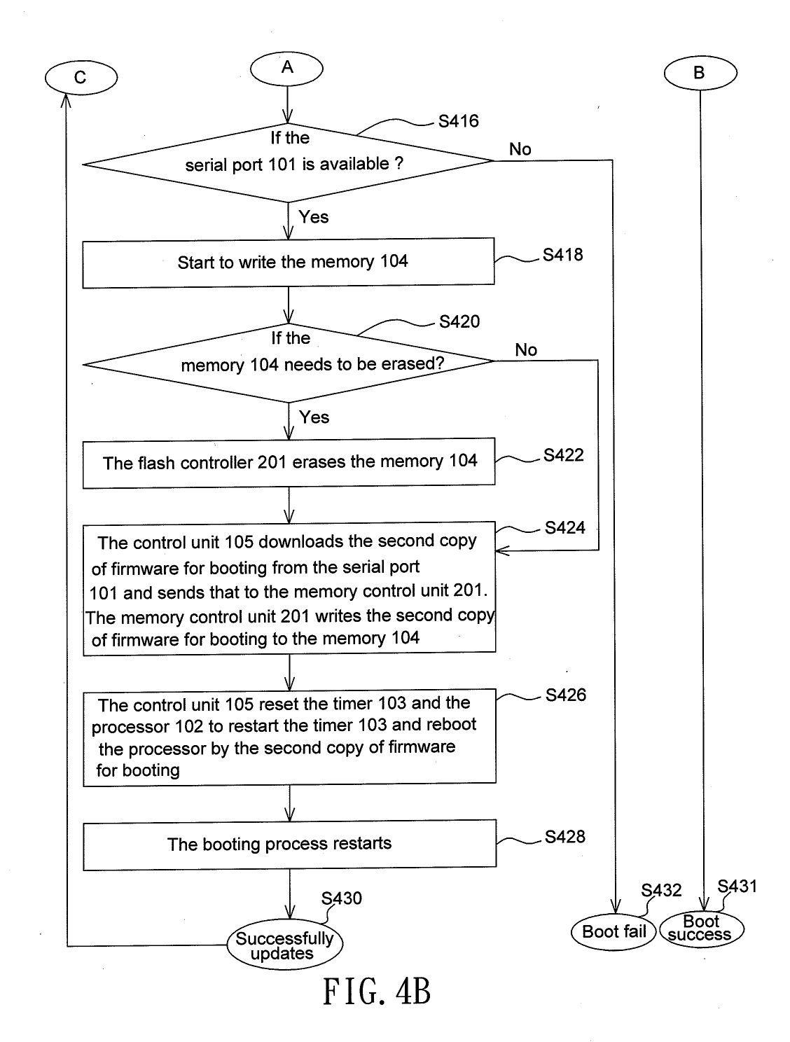

FIGS. 4A and 4B show a flowchart illustrating an embodiment of an auto firmware update method for fault tolerance. The method includes the following steps.

Step S402: A booting process starts.

Step S404: Referring to FIG. 2, the processor 102 boots. The timer 103 starts to count to a preset number in response to the processor booting. In an embodiment, the processor 102 boots according to a first copy of firmware for booting and the first copy of firmware for booting is stored in the memory 104.

Step S406: Determine if the processor 102 successfully boots. If yes, the flow goes to step S408; if no, the flow goes to step S410.

Step 408: The process stops the timer 103 and the flow goes to Step 431.

Step 410: Determine if the timer 103 expires. If yes, the flow goes to step 412; if no, it keeps checking the timer 103.

Step 412: Start the control unit 105.

Step 414: The control unit 105 stops the processor 102.

Step 416: The control unit 105 checks if the serial port 101 is available to provide a second copy of firmware for booting. If yes, the flow goes to Step 418; if no, it indicates the booting process fails and the flow goes to Step 432.

Step 418: Start to write the memory 104.

Step 420: Determine if the memory 104 needs to be erased. If yes, the flow goes to Step 422; if no, the flow goes to Step 424.

Step 422: The flash controller 201 erases the memory 104.

Step 424: The control unit 105 downloads the second copy of firmware for booting from the serial port 101 and sends that to the memory control unit 201. The memory control unit 201 writes the second copy of firmware for booting to the memory 104.

Step 426: The control unit 105 resets the timer 103 and the processor 102 to restart the timer 103 and reboot the processor by the second copy of firmware for booting.

Step 428: The booting process restarts.

Step 430: The firmware is updated successfully. Goes to step 402 for reboot.

Step 431: Boot success.

Step 432: Boot fail. System stopped.

The embodiments of the invention of the auto firmware update device and method for fault tolerance update another copy of firmware for booting through a serial port, if a processor can not successfully boot by its built-in copy of firmware until the timer expires. This solution can provide a fault-tolerant solution for a copy of firmware with errors without requiring human intervention. A further advantage is that it does not require even a single instruction of the bad copy of the firmware to execute successfully in order to successfully boot from the good copy of the firmware. Another advantage is that a designer does not need to pull out an SOC chip with bad copy of the firmware from a circuit board and re-write another copy of firmware to the SOC chip. This can solve the problems of prior art.

Although the present invention and its objects, features, and advantages have been described in detail, other embodiments are encompassed by the invention. For example, the device and method described herein may be employed in any system that has a non-violate memory for storing copies of firmware updated from a serial port that be booted therefrom. In addition, although embodiments have been described having two copies of updated firmware for booting, the invention may be expanded to more than two copies of the updated firmware to provide increased fault-tolerance. In this embodiment, the memory may be expanded in capacity and the serial port may be expanded in port numbers to accommodate the multiple copies of firmware such that the processor attempts to boot the firmware copies in turn until a good copy boots. Furthermore, the device and method described herein may be employed for various sizes and types of memories employed to store copies of firmware.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. An auto firmware update device for fault tolerance, comprising:
a serial port;
a processor for fetching instructions to boot;
a timer, configured to start counting whenever the processor boots
or restart, wherein the timer generates a alarm signal if the
timer expires before the processor successfully boots;
a memory, for storing a copy of firmware for booting; and
a control unit, for receiving the alarm signal to stop the processor, downloading another copy of firmware for booting through the serial port to write to the memory, and restarting the processor and the timer.

2. The auto firmware update device according to claim 1, wherein the memory is a re-writable non-volatile memory.

3. The auto firmware update device according to claim 1, wherein the serial port is a UART port or a USB port.

4. The auto firmware update device according to claim 1, the memory is a flash memory.

5. The auto firmware update device according to claim 4, further comprising a flash control unit for updating the flash memory.

6. The auto firmware update device according to claim 4, which is applied to a SOC chip.

7. The auto firmware update device according to claim 1, wherein the serial port is coupled to a device which stores another copy of firmware for booting.

8. The auto firmware update device according to claim 7, wherein the device is a computer.

9. An auto firmware update method for fault tolerance, comprising:
starting a timer in response to a processor booting wherein the processor boots according to a first copy of firmware for booting;
starting a control unit to stop the processor and checking whether a serial port is available to provide a second copy of firmware for booting if the timer expires before the processor successfully boots;
writing the second copy of firmware for booting from the serial port to a memory; and
restarting the timer and rebooting the processor by the second copy of firmware for booting.

10. The auto firmware update method according to claim 9, further comprising: starting a control unit to stop the timer if the processor successfully boots.

11. The auto firmware update method according to claim 9, wherein the memory is a re-writable non-volatile memory.

12. The auto firmware update method according to claim 11, further comprising: erasing the non-volatile memory if the re-writable non volatile memory needs to be erased.
